(19) United States
(12) Patent Application Publication
(10) Pub. No.: US 2007/0143356 A1
(43) Pub. Date: Jun. 21, 2007

(54) Enforcing workflow for implementing unique identification

(76) Inventors: Richard A. Kleinsmith, Covina, CA (US); Jeffrey O. Stahl, Moreno Valley, CA (US); Andre R. Vadrevu, Yorba Linda, CA (US); Eugene R. Field, Yorba Linda, CA (US)

Correspondence Address: HARNESS DICKEY & PIERCE, PLC, P.O. BOX 828, BLOOMFIELD HILLS, MI, 48303, US

(21) Appl. No.: 11/304,926

(22) Filed: Dec. 15, 2005

(51) Int. Cl. G06F 17/30

(52) U.S. Cl. 707/201

(57) ABSTRACT

A computer-performed method of providing unique identifiers (UIDs) for items. Input indicating one or more items is received. A UID is issued for one of the one or more items. The issued UID is stored in a database. The method includes controlling access to the database to enforce a workflow for coordinating performance of a plurality of functions relative to implementing the issued UID.

### FIELD

The present disclosure relates generally to marking and tracking of inventory, property and equipment and, more particularly but not exclusively, to providing items with unique identifiers.

### BACKGROUND

The statements in this section merely provide background information related to the present disclosure and may not constitute prior art. The United States Government Accountability Office (GAO) and other auditors have repeatedly found that the federal government lacks complete and reliable information pertaining to government inventory, property and equipment. This lack of reliable information makes it difficult for managers of government assets to track and safeguard assets and/or determine the full costs associated with such assets. To address these and other problems, the United States Department of Defense has issued a Unique Identification (UID) policy whereby items to which the government takes title are required to be uniquely identified.

### SUMMARY

The present disclosure, in one aspect, is directed to a computer-performed method of providing unique identifiers (UIDs) for items. Input indicating one or more items is received. A UID is issued for one of the one or more items. The issued UID is stored in a database. The method includes controlling access to the database to enforce a workflow for coordinating performance of a plurality of functions relative to implementing the issued UID.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram of a system for providing unique identifiers (UIDs) in accordance with one aspect of the disclosure;

FIG. 2 is a diagram of various table formats of a database in accordance with one aspect of the disclosure;

FIG. 3 is a flow diagram of UID status in accordance with one aspect of the disclosure;

FIG. 4 is a flow diagram of a workflow for providing and implementing UIDs in accordance with one aspect of the disclosure;

FIGS. 5A through 5F illustrate frames displayed in a user interface in accordance with one aspect of the disclosure; and

FIG. 6 illustrates a sample transmittal sheet in accordance with one aspect of the disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. In various descriptions of aspects of unique identification (UID), the term “item” is commonly used to refer to an assembly or subassembly having component parts. Frequently it is desirable to uniquely identify both items and parts of items. Unless specifically indicated otherwise, however, the terms “item” and “part” are used interchangeably in this disclosure and in the claims.

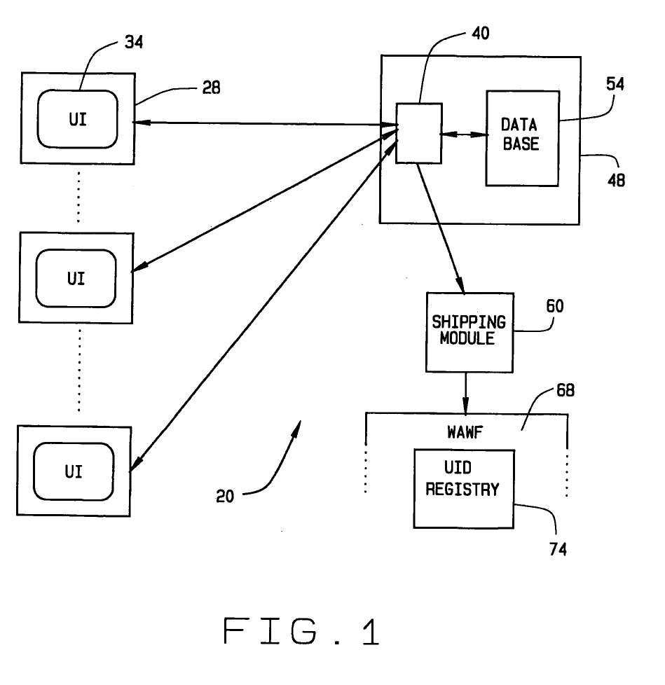

Various implementations of the present disclosure are directed to a computer-performed method and system for providing unique identifiers (UIDs) for items. Such systems and methods may be used, for example, by one or more business enterprises which may be contractually required to include UIDs on items provided to agencies of the United States government. A diagram of one implementation of a system for providing UIDs is indicated generally in FIG. 1 by reference number 20. The system 20 includes one or more user terminals 28 which may be personal computers or other processing devices.

Each user terminal 28 provides a user interface (UI) 34 by which a user may communicate with a UID software application or tool 40 residing in a computer 48. Although a single computer 48 is shown in FIG. 1, it should be noted that various configurations including more than one computer could be used. A UI 34 may include, e.g., a web browser or other interface through which a user may access an enterprise network and/or the Internet. It also should be noted that although various system aspects are web-based (e.g., a web browser may be used and/or communication may take place using the World-Wide Web of the Internet), at least some communication may performed over one or more local area networks (LANs), other Internet means and/or other wide-area network(s).

The UID software tool 40 is in communication with a database 54, e.g., an Oracle® database. The tool 40 may also communicate with a shipping module 60 that may reside in the same computer as the UID tool 40 and/or the database 54, or in a different computer. The shipping module 60 could, for example, reside in one of the user terminal(s) 28 and/or in an enterprise computer at an enterprise facility remote from the computer 48. One or more of the terminal(s) 28 also may be remote from the computer 48 and/or shipping module 60. It will be evident to those skilled in the art that many different computer and network configurations could be used to implement various aspects of the disclosure. Links may be established via the Internet between the shipping module 60 and a Wide Area Work Flow (WAWF) website 68. Information from the shipping module 60 may be delivered via the website 68 to a UID registry 74 maintained by a governmental or other agency, e.g., by the United States Department of Defense (DoD).

There are many possible configurations of the system 20 with respect to one or more enterprises that may use all or part(s) of the system 20. For example, a single enterprise or more than one enterprise may have UIs 34 configured for accessing the tool 40 and/or database 54. The tool 40 may be configured to interface with various business systems although it could be used independently if desired. Additionally or alternatively, the shipping module 60 could be available to one or more than one enterprise.

The terms defined below may be used in the present disclosure.
EID—Enterprise Identifier: A code that is uniquely assigned to an Enterprise by a registered issuing agency.
CAGE—Commercial and Government Entity identifier; CAGE code is one form of EID.
GFE—Government Furnished Equipment
GFP—Government Furnished Property
IAC—Issuing Agency Code
IPT—Integrated Product Team
SER—Text Element Identifier for serial number (as used in the UID)
UCN—Text Element Identifier for unique component number (as used in the UID)
UID—Unique Identification or Unique Identifier:
UID Type—Refers to the following choices for a type of UID:
   UID1—UID Construct 1, or serialization within the Enterprise Identifier
   UID2—UID Construct 2, or serialization within the original part number
   ESN—Electronic Serial Number
   GIAI—Global Individual Asset Identifier
   GRAI—Global Returnable Asset Identifier
   VIN—Vehicle Identification Number

In some implementations, the tool 40 receives input, e.g., from a UI 34, indicating one or more items to be assigned a UID. The tool 40 issues UIDs for the item indication(s). The tool 40 causes the issued UID to be associated with (e.g., related to) the item indication in the database 54. As further described below, the tool 40 controls user access to the database 54 to enforce a workflow for implementing the issued UID relative to the indicated item.

More specifically, the tool 40 generates serial numbers and component numbers that are unique within any given EID, e.g., within a given CAGE code. The application uses tables of the database 54 to issue, track, and maintain the serial numbers and component numbers for use in Unique Identification (UID). Within the tool 40 and database 54, CAGE codes, program codes, and other pertinent information are associated with the serial and component numbers generated by the tool 40.

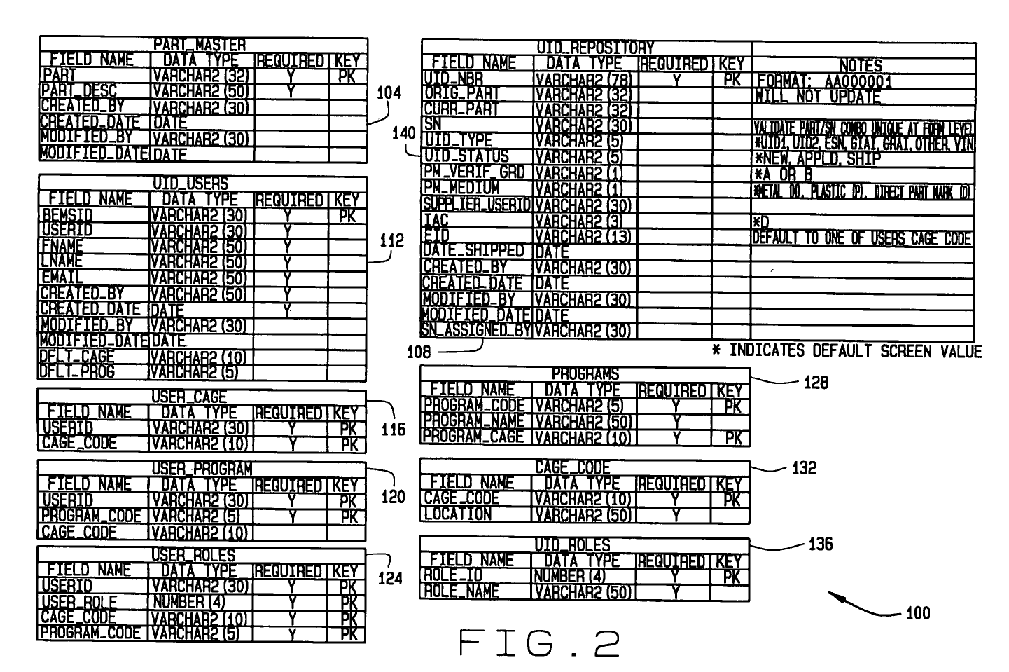

A diagram of various table formats of the database 54 are indicated generally in FIG. 2 by reference number 100. The tables include a “PART_MASTER” table 104, a “UID_REPOSITORY” table 108, a “UID_USERS” table 112, a “USER_CAGE” table 116, a “USER_PROGRAM” table 120, a “USER_ROLES” table 124, a “PROGRAMS” table 128, a “CAGE_CODE” table 132, and a “UID_ROLES” table 136. Among other fields, a “UID_STATUS” field 140 of the “UID_REPOSITORY” table 108 may be used to indicate a current status of a UID number and a part to which it corresponds. It should be noted that the tables, table entries and values shown in FIG. 2 are exemplary only, and other or additional tables, entries and/or values may be used.

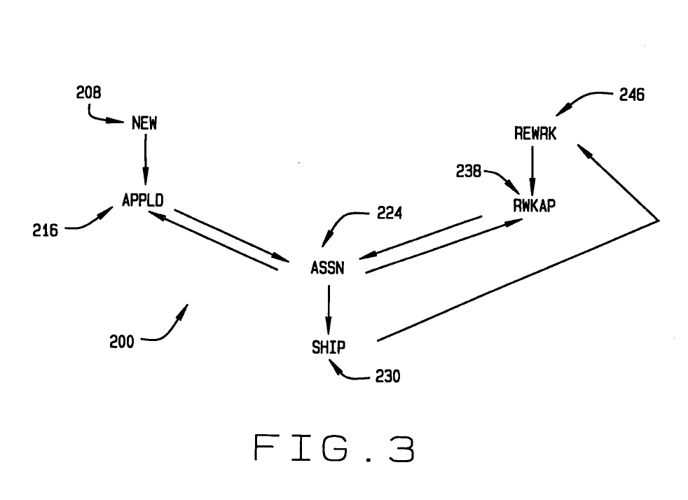

An exemplary flow diagram of UID status is indicated generally in FIG. 3 by reference number 200. As further described below, the tool 40 tracks the status of a UID from creation of the UID through shipping of a part labeled with the UID from an enterprise to a customer, and in the event that the part is returned to the enterprise for reworking. Further, by controlling access to the database 54 and by restricting updates by tool users of UID status, the tool 40 enforces a workflow for implementing the UID.

As previously mentioned, the “UID_STATUS” field 140 of the “UID_REPOSITORY” table 108 is used to store a current status of a UID. Referring now to FIG. 3, when a UID is created, it is assigned a “NEW” status 208 in the “UID_REPOSITORY” table 108. After a UID label has been applied to an item or part, the “UID_STATUS” field 140 is updated with an “APPLD” status 216. After the UID label and its application to the part have been inspected and approved and the labeled part has been assigned for shipment, the “UID_STATUS” field 140 is updated with an “ASSN” status 224. After the part has been shipped to a customer, the “UID_STATUS” field 140 is updated with a “SHIP” status 230. A status REWRK 246 is used if a part is returned to the enterprise for reworking. Since the part and its UID already exist in the system with a status of SHIP, it cannot be given a status of NEW. Therefore, when the part is returned, a user changes the status in the tool 40 from SHIP to REWRK.

The REWRK status 246 can flow to a status RWKAP 238. The status RWKAP is similar to APPLD 216. If a part and/or label are scrapped, the “UID_STATUS” field 140 is updated to “SCRAP” (not shown). It should be noted that “SCRAP” cannot be assigned to the “UID_STATUS” field 140 if the current status is “ASSN” or “SHIP”. It also should be noted that different or additional statuses could be used in various implementations to indicate different and/or additional workflow conditions and/or directions.

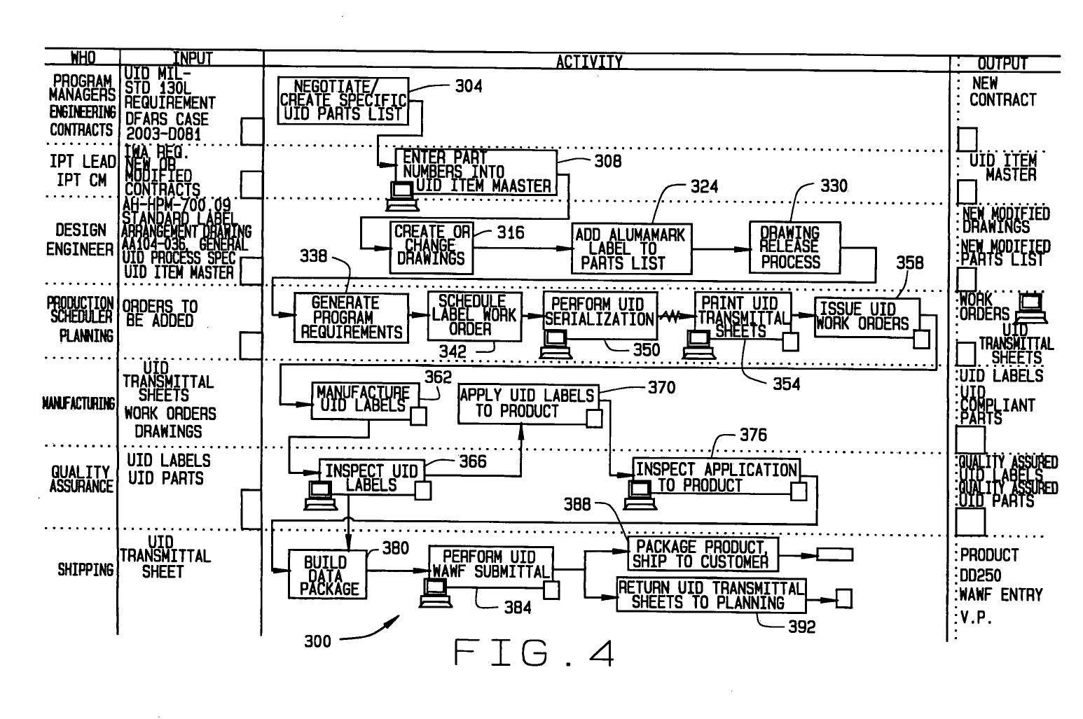

A flow diagram of an exemplary workflow for providing and implementing UIDs that can be enforced using implementations of the foregoing system is indicated generally in FIG. 4 by reference number 300. In negotiating a contract with a U.S. government agency, program managers and engineering and contracting personnel typically specify various items to be provided with UIDs in accordance with contract and governmental requirements. Thus in step 304 a specific UID parts list is created and included in the terms of the contract. In step 308 the part numbers are entered via one or more terminals 28 and added to the “PART_MASTER” table 104 (also referred to as “UID Item Master”) in the database 54. The part numbers are added, for example, by an IPT member using the tool 40.

The “PART_MASTER” table 104 is accessible, for example, by design engineer(s) who in step 316 create or change drawings for labels that are to include UIDs corresponding to the part numbers. In step 324 the design engineer(s) add the labels, which in the present example are to be made of aluminum material, as parts to the UID parts list. In step 330 the label drawings are submitted to a release process wherein the drawings, which have been changed to show the labels and where on the parts the labels are to be applied, are approved and stored for future reference.

In step 338 production scheduling and planning personnel generate program requirements and in step 342 schedule one or more label work orders. In step 350 the production scheduling and planning personnel use the tool 40 to perform UID serialization to generate UIDs corresponding to parts included in the “PART_MASTER” table 104. The tool 40 generates UIDs that have serial numbers and component numbers which are unique within any given EID, e.g., CAGE code. The tool 40 stores the UIDs in the “UID_REPOSITORY” table 108 of the database 54 and the “UID_STATUS” field 140 for the newly created UIDs is set to “NEW”.

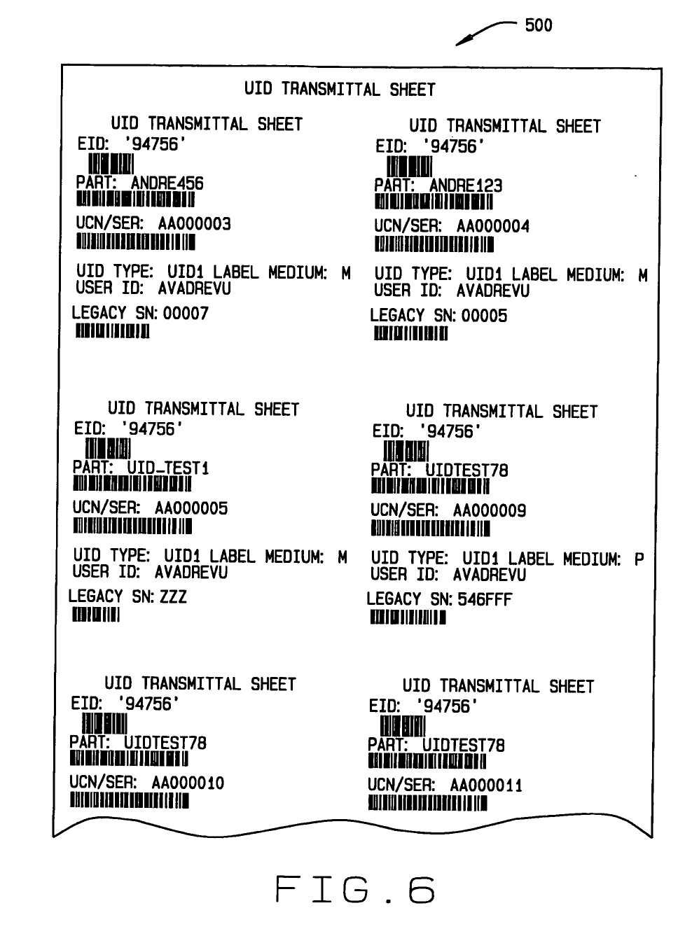

In step 354 the tool 40 prints UID transmittal sheets which may be used in shipping as further described below. An exemplary transmittal sheet is indicated generally in FIG. 6 by reference number 500. The transmittal sheet 500 includes the following information:

EID (Man readable and barcode)

Part number (Man readable and barcode)

UCN/SER (Man readable and barcode)

UID Type (Man readable only)

Label Medium (Man readable only)

User ID (Man readable only)

Legacy Serial Number (Man readable and barcode)

The tool 40 in step 358 generates UID work orders for producing UID labels. In step 362 manufacturing personnel use the UID transmittal sheets, work orders and drawings to manufacture UID labels. Labels may be made, e.g., by inputting aluminum material to a laser. Such material may be, e.g., AlumaMark™ material by Horizons Inc. of Cleveland, Ohio. In step 366 the labels are inspected and may be approved, e.g., by quality assurance personnel. The quality assurance personnel input the inspection results to the tool 40, which uses the results in building a data package as further described below. Approved labels are applied to their corresponding parts in step 370 by manufacturing personnel. In step 376 the application of the labels to the parts is inspected by quality assurance personnel to ensure that the parts and labels are UID-compliant. The quality assurance personnel input the inspection results to the tool 40, which stores the results and updates the “UID_STATUS” fields to “APPLD”.

In step 380 the UID transmittal sheet produced in step 358 and inspection results from steps 366 and 376 are retrieved and used by shipping personnel to build a data package, e.g., a DD Form 250. In step 384, shipping personnel use the tool 40 and the shipping module 60 to submit the data package as a WAWF submittal to the Wide Area Work Flow (WAWF) website 68. Shipping personnel also update the “UID_STATUS” fields in the database 54 to “ASSN”. In step 388 the UID-labeled product is shipped to a customer and the “UID_STATUS” fields are updated to “SHIP”. In step 392 the UID transmittal sheets are returned to planning personnel.

If a part or item is returned for rework, a user looks up that item in the tool 40 and changes the status from SHIP to REWRK. When the item has been successful reworked it flows back through quality assurance. When the item has been inspected and approved by quality assurance personnel, the quality assurance personnel update the status in the tool 40 for that item to RWKAP. The process then continues in the same or a similar manner as a new item.

It should be noted that the foregoing workflow is exemplary only and that other or additional workflows could be integrated and enforced in the system 20. For example, UIDs could be assigned to government-furnished property and/or government-furnished equipment (GFP and/or GFE) which could, e.g., be labeled and kept on the premises of an enterprise in accordance with a workflow enforced by the tool 40.

Various aspects of operation of the tool 40 shall now be described in greater detail.

Overview of Tabs and Menus

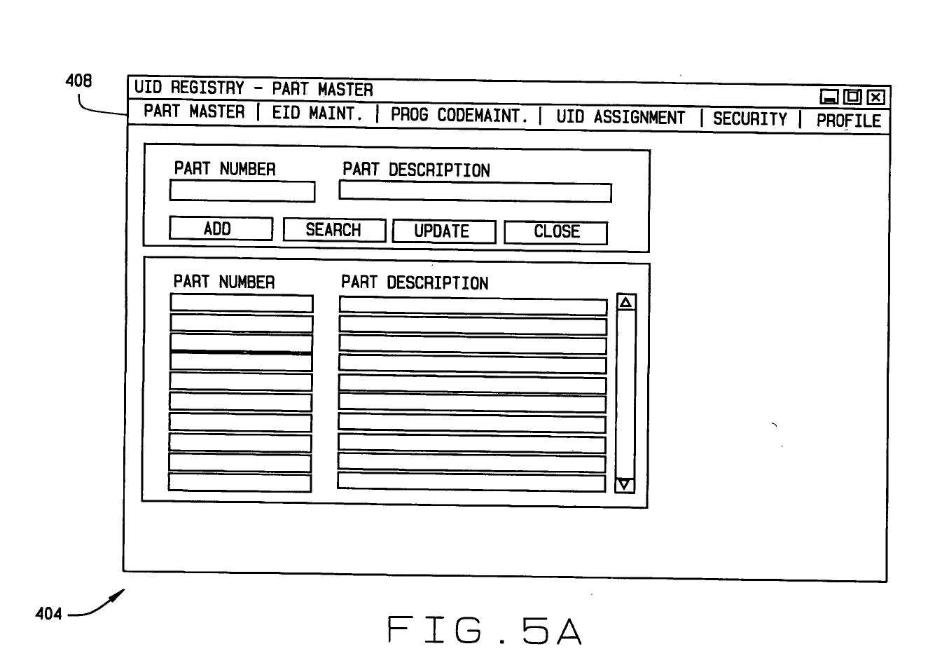

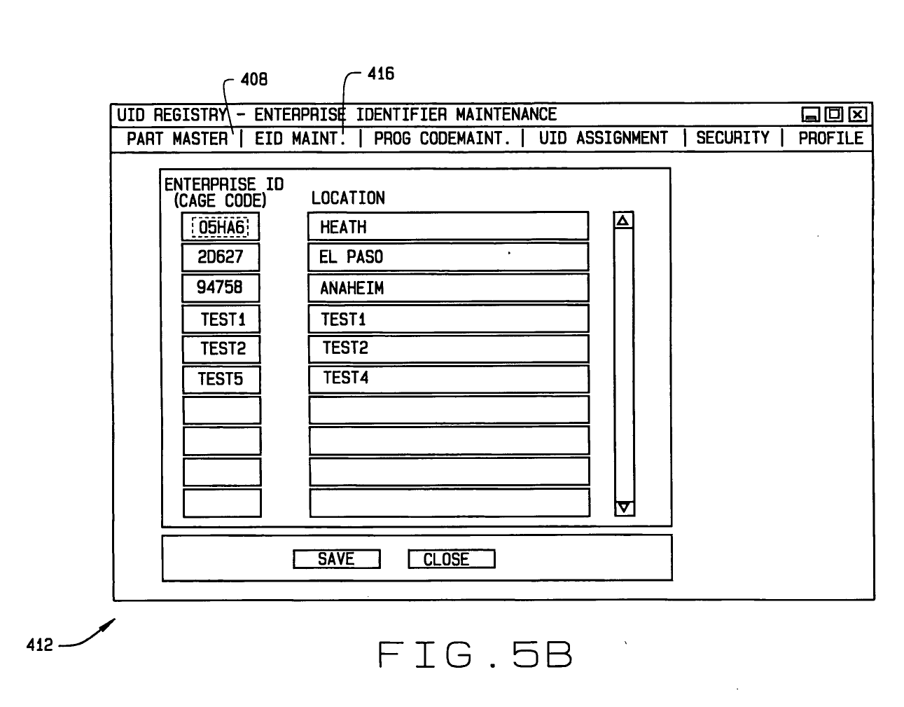

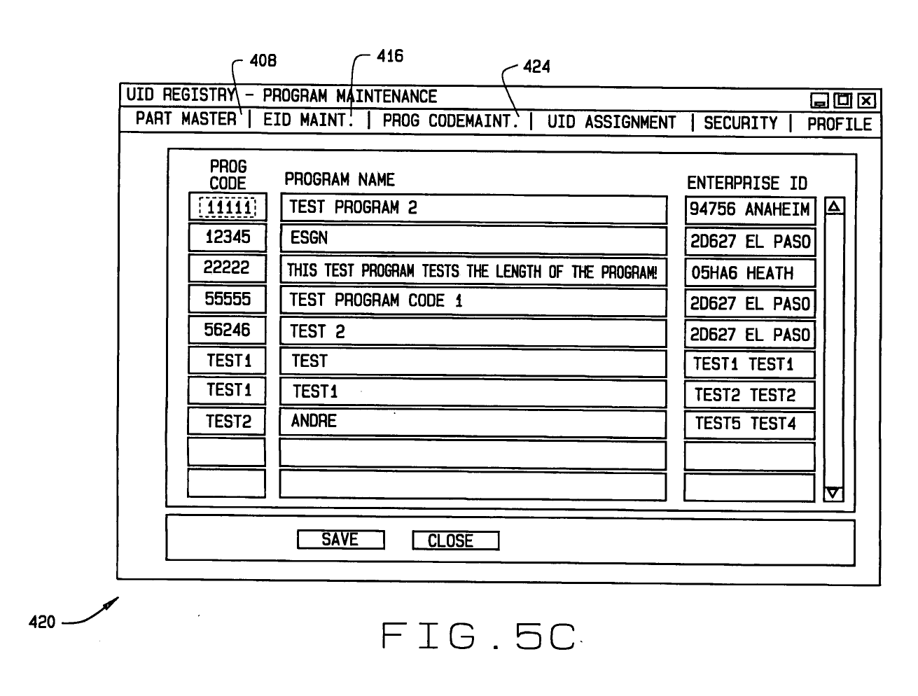

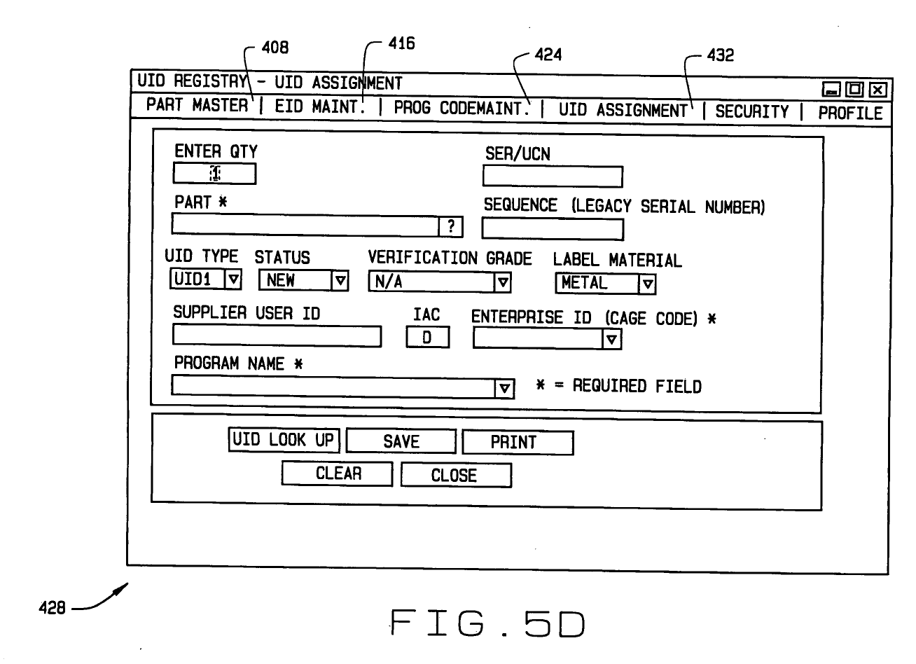

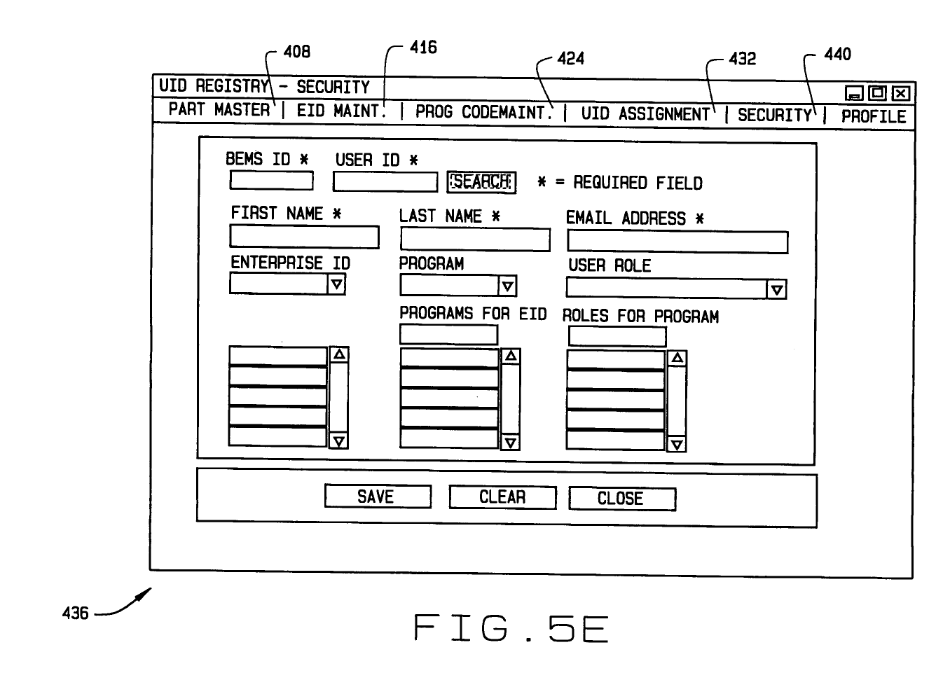

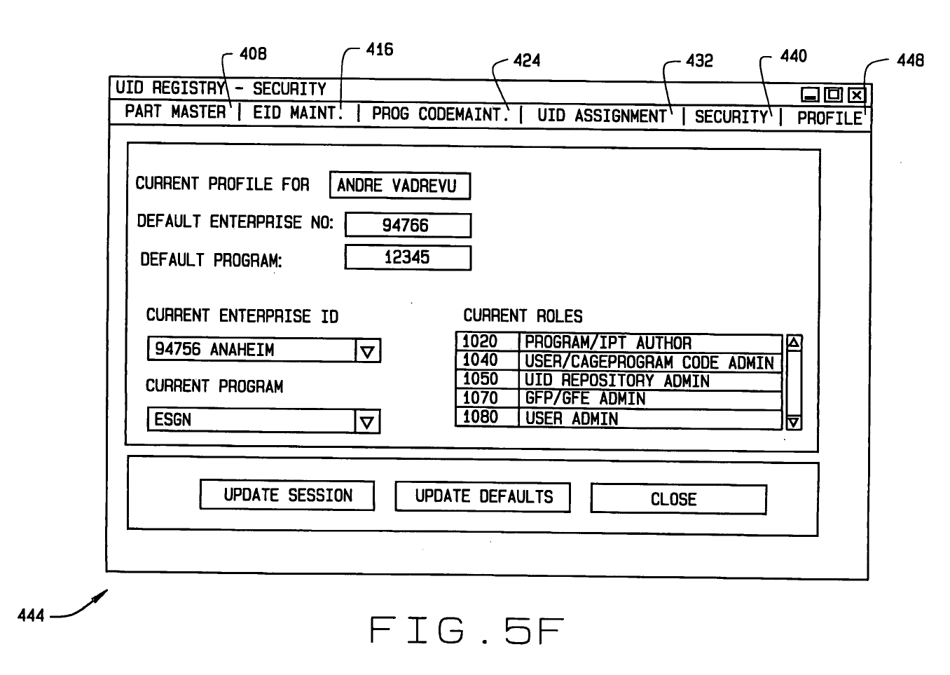

The tool 40 presents various tabs and menus to a user via the UI 34. Various frames provided by the tool 40 are shown in FIGS. 5A through 5F. A frame 404 is displayed as shown in FIG. 5A when a “Part Master” tab 408 has been selected by a user. A frame 412 is displayed as shown in FIG. 5B when an “EID Maintenance” tab 416 has been selected. A frame 420 is displayed as shown in FIG. 5C when a “Program Code Maintenance” tab 424 has been selected. A frame 428 is displayed as shown in FIG. 5D when a “UID Assignment” tab 432 has been selected. A frame 436 is displayed as shown in FIG. 5E when a “Security” tab 440 has been selected. A frame 444 is displayed as shown in FIG. 5F when a “Profile” tab 448 has been selected. Uses for the for the foregoing frames shall now be described with reference to various access rights which may be assigned to users by the tool 40.

Overview of User Roles and Access Rights

A user having a Reader/Searcher role may view and search using the “UID Assignment” tab 432 and reports only. Access is read-only. The user may look up UIDs. Only information pertaining to CAGE codes and programs to which the user has access will appear.

A user having an Inspector role may view and search using the “UID Assignment” tab 432 and reports only. Access is read-only with one exception: an Inspector may use the “UID Assignment” tab 432 to update UID Status 140. Only information pertaining to CAGE codes and programs to which the user has access will appear. Quality assurance personnel are typically assigned the Inspector role.

A user having a Program/IPT Author role may view and search using the “Part Master” tab 408 and “UID Assignment” tab 432 and related reports only. A Program/IPT Author may use the “Part Master” tab 408 to add part numbers and descriptions to the “Part Master” table 104 and can search, but cannot update, existing part numbers or descriptions. A Program/IPT Author can use the “UID Assignment” tab 432 to perform UID assignment. The user may navigate between the “Part Master” and “UID Assignment” tabs to input part numbers and assign corresponding UIDs as desired. Only information pertaining to CAGE codes and programs to which the user has access will appear. IPT and scheduling personnel are typically assigned the Program/IPT Author role.

A user having a GFP/GFE Author role may view and search using the “Part Master” tab 408 and “UID Assignment” tab 432 and related reports only. A GFP/GFE Author may add part numbers and descriptions to the “Part Master” table 104, but cannot update existing part numbers or descriptions. A GFP/GFE Author may perform UID assignment. A GFP/GFE Author can access all CAGE codes and programs. Property administrators are typically assigned the GFP/GFE Author role.

A user having a User Cage/Program Code Administrator role may add and/or remove CAGE codes and Program codes relative to users' accounts. In other words, a User Cage/Program Code Administrator can control user access by CAGE code and program code assignments but cannot add new users. A User Cage/Program Code Administrator has access only to the “Security” tab 440.

A user having a UID Repository Admin role can search existing part numbers and add new ones. A UID Repository Admin can also change part numbers and descriptions of existing entries and can modify existing Enterprise IDs (e.g., CAGE codes) and locations and add new CAGE codes and locations. A UID Repository Admin can use the “Program Code Maintenance” tab 424 to add new program names and program codes and can change the enterprise ID of existing entries and otherwise modify existing entries.

A user having a Program/IPT Admin role may add and/or remove user roles on existing users. A Program/IPT Admin can only modify users with the same program code and cannot modify users' program or CAGE assignments. A Program/IPT Admin has access only to the “Security” tab 440. IPT personnel are typically assigned the Program/IPT Admin role.

A user having a GFP/GFE Admin role may add and/or remove user roles on existing users. A GFP/GFE Admin can modify any user but cannot modify users' program or CAGE assignments. Property administrative personnel are typically assigned the GFP/GFE Admin role.

A user having a User Admin role may add and/or remove user security (access) information such as BEMS ID, User ID, First Name, Last Name, and Email Address but cannot add or modify CAGE, program, or role.

Implementations of the present disclosure make it possible to coordinate performance of a plurality of functions and activities relative to the issuance and application of UIDs. Such functions and activities include but are not limited to contracts, engineering, facilities, finance, manufacturing engineering, material, property accountability and control, quality, shipping, supplier management and procurement. Configurations in accordance with the present disclosure may be implemented in a plurality of sites of an enterprise and may also be implemented in connection with a plurality of enterprises. For example, the database 54 could be used by a plurality of enterprises. Opportunistic marking could be performed in accordance with the present disclosure. Varied levels of user access, e.g., by use, by site, and/or by program, and predetermined status flow enforced by the tool and database structures make it possible to provide standardized processes and standardized documents.

Implementations of the present disclosure allow a contractor to assign UIDs to parts, items, property, spares, material, etc. in a database prior to applying a UID mark or tag. Further, such UIDs could be sent via the WAWF website to update one or more governmental databases, e.g., a database PIPC (Property in the Possession of Contractors) maintained by the U.S. Department of Defense.

While various embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

What is claimed is:

1. A computer-performed method of providing unique identifiers (UIDs) for items, the method comprising:
receiving input indicating one or more items;
issuing a UID for one of the one or more items;
storing the issued UID in a database; and
controlling access to the database to enforce a workflow for coordinating performance of a plurality of functions relative to implementing the issued UID.

2. The method of claim 1, wherein the functions are performed to implement the issued UIDs in accordance with one or more governmental requirements.

3. The method of claim 1, wherein the functions are related to at least one of the following: contracting, engineering, facilities, finance, manufacturing engineering, material, property accountability and control, quality, shipping, supplier management and procurement.

4. The method of claim 1, wherein issuing a UID comprises issuing a number that is unique within a given enterprise identifier (EID).

5. The method of claim 1, wherein controlling access to the database comprises controlling entry into the database of a change of status of an issued UID.

6. The method of claim 1, wherein controlling access to the database is role-based.

7. A computer-performed method of providing unique identifiers (UIDs) for items, the method comprising:
receiving input indicating one or more items;
issuing a UID for one of the one or more item indications;
relating the issued UID with the item indication in a database; and
enforcing a workflow for implementing the issued UID relative to the indicated item, said enforcing performed by:
controlling access by a user to the database; and
using a status of the issued UID in the database to indicate to the user whether an action in the workflow is to be performed.

8. The method of claim 7, wherein implementing the issued UID relative to the indicated item comprises labeling the indicated item with a label that includes the UID.

9. The method of claim 8, wherein implementing the issued UID relative to the indicated item further comprises shipping the labeled item to a customer.

10. The method of claim 7, further comprising controlling user access to the database based on a role of the user.

11. A system for providing unique identifiers (UIDs) for items, the system comprising:
a computer configured to receive input indicating one of the items and to assign a UID to the item based on the input; and
a database configured to associate the item indication with its assigned UID;
the computer further configured to impose role-based conditions for accessing the database and for changing a status in the database of the assigned UID, to support a role-based workflow for implementing the assigned UID relative to the item.

12. The system of claim 11, configured to deliver the assigned UID to a customer registry.

13. The system of claim 11, wherein the workflow comprises labeling the indicated item with a label that includes the assigned UID.

14. The system of claim 13, wherein the workflow further comprises shipping the labeled item to a customer.

15. The system of claim 11, further comprising a shipping module configured to use the assigned UID and the item indication to produce a data package for submission to a customer registry.

16. The system of claim 15, wherein the submission is performed using the Internet.
